(19) United States
(12) Patent Application Publication
(10) Pub. No.: US 2026/0309845 A1
(43) Pub. Date: Oct. 8, 2026

(54) SENSOR ASSEMBLY AND METHOD OF OPERATING A VEHICLE WITH THE SENSOR ASSEMBLY

(71) Applicant: GM GLOBAL TECHNOLOGY OPERATIONS LLC, Detroit, MI (US)

(72) Inventors: Jesse Heidrich, Shelby Township, MI (US); Joel S. Hooton, Chesterfield, MI (US); Joshua L. Solomon, Berkley, MI (US); Benjamin Walker, Clinton Township, MI (US); Kevin K. Parkila, Royal Oak, MI (US)

(73) Assignee: GM GLOBAL TECHNOLOGY OPERATIONS LLC, Detroit, MI (US)

(21) Appl. No.: 19/170,253

(22) Filed: Apr. 4, 2025

(51) Int. Cl. G01S 7/481; G01S 17/931; G05D 1/622; G05D 109/10; G05D 111/10

(52) U.S. Cl. CPC G01S 7/481; G01S 17/931; G05D 1/622; G05D 2109/10; G05D 2111/17

(57) ABSTRACT

A vehicle includes a body having a base portion spaced from an upper portion and a sensor portion separating the upper portion from the base portion. The sensor portion includes at least one sensor located between the base portion and the upper portion with a support structure circumferentially spaced around the at least one sensor and configured to engage the base portion and the upper portion. The vehicle also includes a drive unit having a drive motor in driving engagement with drive wheels that are configured to engage a support surface and guide wheels rotatably attached to the base portion for supporting the vehicle along the support surface.

### BACKGROUND

The present disclosure relates to sensor assemblies, and more particularly, to a sensor assembly and method for operating a vehicle with the sensor assembly.

In the rapidly evolving landscape of logistics and supply chain management, autonomous mobile robots (AMRs) have emerged as a transformative solution for warehouse operations, addressing critical challenges of labor shortages, operational inefficiencies, and increasing consumer demands for rapid fulfillment. If an AMR becomes damaged, the fulfillment process can be slowed, and significant resources can be spent repairing the AMR.

### SUMMARY

Disclosed herein is a vehicle. The vehicle includes a body having a base portion spaced from an upper portion and a sensor portion separating the upper portion from the base portion. The sensor portion includes at least one sensor located between the base portion and the upper portion with a support structure circumferentially spaced around the at least one lidar sensor and configured to engage the base portion and the upper portion. The vehicle also includes a drive unit having a drive motor in driving engagement with drive wheels that are configured to engage a support surface and guide wheels rotatably attached to the base portion for supporting the vehicle along the support surface.

In one aspect of the disclosure the support structure includes columns surrounding the at least one sensor.

In one aspect of the disclosure the columns are cylindrical.

In one aspect of the disclosure the columns are quadrilateral.

In one aspect of the disclosure the at least one sensor includes multiple lidar sensors surrounded by the support structure.

In one aspect of the disclosure at least one of the columns at least partially defines a conduit forming a portion of a passageway between the base portion and the upper portion.

In one aspect of the disclosure the support structure forms a first ring surrounding the at least one sensor.

In one aspect of the disclosure the at least one sensor includes a first lidar sensor located at a center of the first ring.

In one aspect of the disclosure the first ring includes a first circular flange with a first set of legs extending from an axially facing surface of the first circular flange.

In one aspect of the disclosure the first set of legs extend in a radial direction that is aligned with the center of the first ring.

In one aspect of the disclosure the support structure includes a second ring having a second circular flange and a second set of legs extending from an axial surface of the second circular flange.

In one aspect of the disclosure the at least one sensor includes a second lidar sensor located at a center of the second ring and axially spaced from the first lidar sensor.

In one aspect of the disclosure the first set of legs are circumferentially offset from the second set of legs.

Disclosed herein is an assembly. The assembly includes a body having a base portion spaced from an upper portion and a sensor portion separating the upper portion from the base portion. The sensor portion includes at least one lidar sensor located between the base portion and the upper portion with a support structure circumferentially spaced around the at least one lidar sensor and configured to engage the base portion and the upper portion. The assembly also includes a controller in electrical communication with the at least one lidar sensor. The controller is configured to direct the at least one lidar sensor on the assembly to emit light in a 360 degree pattern and identify an object surrounding the assembly based on the emitted light reflecting off the object.

In one aspect of the disclosure the support structure includes columns surrounding the at least one lidar sensor.

In one aspect of the disclosure the support structure forms a first ring surrounding the at least one lidar sensor, the first ring includes a first circular flange with a first set of legs extending from an axially facing surface of the first circular flange, and the first set of legs extend in a radial direction that is aligned with a center of the first ring.

In one aspect of the disclosure the support structure includes a second ring having a second circular flange, a second set of legs extending from an axial surface of the second circular flange, and the at least one lidar sensor includes a second lidar sensor located at a center of the second ring and axially spaced from the first lidar sensor.

Disclosed herein is a method of operating an autonomous mobile robot. The method includes emitting light from at least one lidar sensor on the autonomous mobile robot in a 360 degree pattern. The robot includes a body having a base portion spaced from an upper portion and a sensor portion separating the upper portion from the base portion. The sensor portion includes at least one lidar sensor located between the base portion and the upper portion with a support structure circumferentially spaced around the at least one lidar sensor and configured to engage the base portion and the upper portion. The robot also includes a drive unit having a drive motor in driving engagement with drive wheels that are configured to engage a support surface and guide wheels rotatably attached to the base portion for supporting the robot along the support surface. The method also includes identifying an object surrounding the autonomous mobile robot based on the emitted light reflecting off the object and directing the autonomous mobile robot with the drive unit to follow a path based on the object identified by the at least one lidar sensor.

In one aspect of the disclosure the at least one lidar sensor includes a first lidar sensor, the support structure forms a first ring surrounding the first lidar sensor, the first ring includes a first circular flange with a first set of legs extending from an axially facing surface of the first circular flange, and the first set of legs extend in a radial direction that is aligned with a center of the first ring.

In one aspect of the disclosure the support structure includes a second ring having a second circular flange, a second set of legs extending from an axial surface of the second circular flange, and the at least one lidar sensor includes a second lidar sensor located at a center of the second ring and axially spaced from the first lidar sensor.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates an example of an autonomous mobile robot (AMR) having a base portion, an upper portion, and a sensor portion.

FIG. 2 illustrates a lidar coverage diagram for the AMR of FIG. 1.

FIG. 3 illustrates another lidar coverage diagram for another example sensor portion for the AMR of FIG. 1.

FIG. 4 illustrates an enlarged view of the lidar coverage diagram of FIG. 3.

FIG. 5 illustrates yet another lidar coverage diagram for yet another example sensor portion for the AMR of FIG. 1.

FIG. 6 illustrates an enlarged view of the lidar coverage diagram of FIG. 5.

FIG. 7 illustrates an example support structure for a further example sensor portion for the AMR of FIG. 1.

FIG. 8 illustrates an example method of operating the AMR of FIG. 1.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

Vehicles, such as autonomous mobile robots (AMRs), are becoming increasingly popular for use in automated warehouses to transport goods or materials throughout the warehouse. The AMRs are driverless vehicles that are configured to carry a payload or pull a load from an origin location to one or more destinations within a warehouse or other area. Due to the dynamic nature of the environments that AMRs are operated within, it is possible that other objects or vehicles could enter the path of the AMRs. To address this issue, AMRs utilize an object detection system, such as a lidar object detection system, to identify objects in an area surrounding the AMR. One feature of this disclosure is to provide protection for the object detection system on the AMR to prevent it from becoming damaged during use.

FIG. 1 illustrates an example AMR 10. The AMR 10 includes a body 12 having a base portion 14 separated from an upper portion 16 by an intermediate or sensor portion 18. In the illustrated example, the base portion 14 includes a drive unit 20 having at least one drive motor configured to engage drive wheels 22 through a transmission in the drive unit 20 to maneuver the AMR 10 along a support surface 26. In addition to the drive wheels 22, the base portion 14 includes multiple guide wheels 24, such as a pair of front guide wheels adjacent to a front of the AMR 10 and a pair of rear guide wheels adjacent to the rear of the AMR 10 on opposite sides of the drive wheels 22. One feature of the combination of the drive wheels 22 and the guide wheels 24 is to maintain the AMR 10 evenly supported along the support surface 26, such as a floor in a warehouse, during operation of the AMR 10.

A controller 28 can be located in the base portion 14 and is in electrical communication with the drive unit 20 for controlling movement of the AMR 10 and a power supply 30, such as a battery pack, for providing power to the drive unit 20. While the controller 28 is shown in the base portion 14, the controller 28 could be located in another portion of the AMR 10, such as the upper portion 16.

The controller 28 includes at least one processor P and a non-transitory computer-readable storage device or media M. The processor P can be custom-made or commercially available, a central processing unit (CPU), a graphics processing unit (GPU), an auxiliary processor among several processors associated with the controller 28, a semiconductor-based microprocessor (in the form of a microchip or chip set), a microprocessor, a combination thereof, or generally a device for executing instructions. The computer-readable storage device or media M may include volatile and nonvolatile storage in read-only memory (ROM), random-access memory (RAM), and keep-alive memory (KAM), for example. KAM is a persistent or non-volatile memory that may be used to store various operating variables while the processor P is powered down. The computer-readable storage device or media M may be implemented using several other memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 28 in controlling the AMR 10.

The instructions may include one or more separate programs, each of which comprises an ordered listing of executable instructions for implementing logical functions. The instructions, when executed by the processor P, receive and process signals from the sensor portion 18, perform logic, calculations, methods and/or algorithms for automatically controlling the components of the AMR 10, and generate control signals to the drive unit 20 to automatically control the components of the AMR 10 based on the logic, calculations, methods, and/or algorithms. Although a single controller 28 is shown in FIG. 1, embodiments of the AMR 10 may include a number of controllers 28 that communicate over a suitable communication medium or a combination of communication mediums and that cooperate to process the sensor signals, perform logic, calculations, methods, and/or algorithms, and generate control signals to automatically control features of the AMR 10.

In the illustrated example of FIG. 1, the sensor portion 18 includes columns or supports 32 that form a support structure extending between the upper portion 16 and the base portion 14. The support structure can be coated with an anti-reflective coating to reduce its visibility. The sensor portion 18 includes at least one lidar sensor 36 depending on the application and a desired level of coverage for detecting objects in the area surrounding the AMR 10. Furthermore, at least one optical sensor, such as a camera, could be used in place of or in addition to the at least one lidar sensor 36. In the illustrated example of FIG. 1, the supports 32 are cylindrical and can include a passageway or conduit C creating a passage between the base portion 14 and the upper portion 16 to allow for wires or other elements to pass through the sensor portion 18 with minimal interferences to the lidar sensor 36.

One feature of the sensor portion 18 is to protect the lidar sensors 36 from colliding with another object during use of the AMR 10 and causing damage to the AMR 10. For example, by locating the lidar sensors 36 inward from a perimeter of the body 12, the body 12 can deflect objects and prevent damage to the lidar sensors 36 which can be sensitive to being misaligned or broken during use. Furthermore, the sensor portion 18 is configured to reduce interference with light beams emitted from and received by the lidar sensor 36 to prevent or reduce blind spots for the lidar sensor 36 on the AMR 10.

The upper portion 16 includes a support surface 40 for carrying a payload or for attaching to a trailer (not shown). Alternatively, a trailer or similar device can be removably attached to the base portion 14. The weight of the payload is transferred through the support structure of the sensor portion 18 to the base portion 14 and into the support surface 26 through the drive wheels 22 and guide wheels 24.

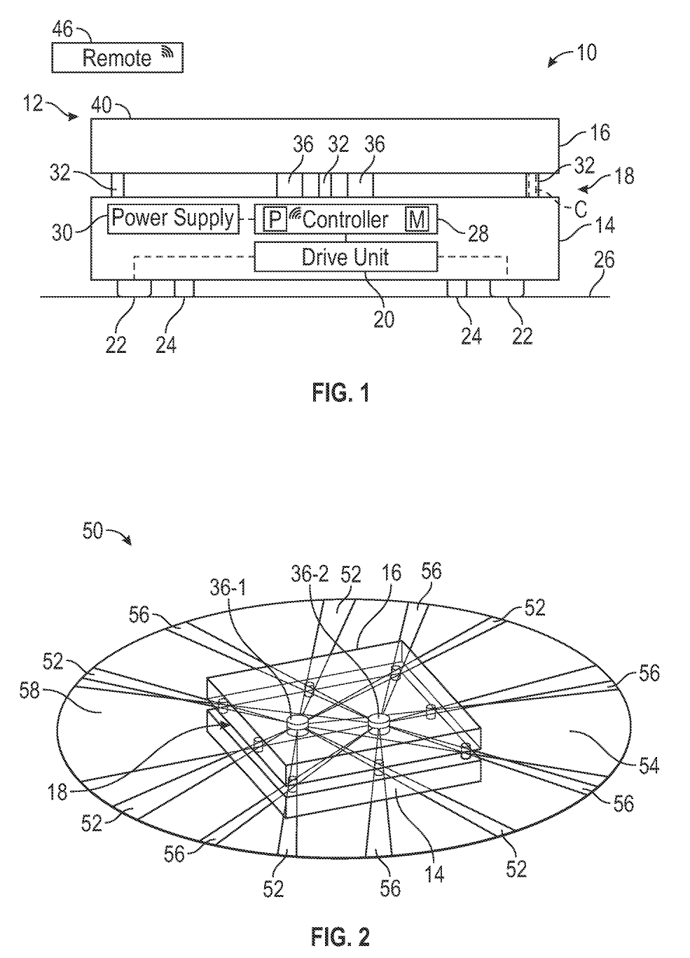

FIG. 2 represents a lidar coverage diagram 50 for the AMR 10 shown in FIG. 1. For illustrative purposes, the base portion 14 and the upper portion 16 are schematically represented as boxes for ease of illustration. Additionally, the base portion 14 and upper portion 16 could form portions of a fixed structure, such as a post or column, with the sensor portion 18 located in the fixed structure. In particular, the sensor portion 18 can be incorporated into posts or columns in a robot cell fencing system to prevent the sensors within the sensor portion from coming into contact with surrounding vehicles.

As shown in FIG. 2, a first lidar sensor 36-1 and a second lidar sensor 36-2 are located in the sensor portion 18 between the base portion 14 and the upper portion 16 and inward from a perimeter of the base portion 14 and the upper portion 16. Furthermore, the first and second lidar sensors 36-1 and 36-2 are located in a central region of the sensor portion 18 and spaced from the perimeter of the body 12 by the supports 32. The first and second lidar sensors 36-1 and 36-2 are each configured to emit and receive light beams in 360 degrees as instructed by the controller 28.

The supports 32 forming the support structure are circumferentially spaced around the sensor portion 18 and inward from a perimeter of the base portion 14 and the upper portion 16. In the illustrated example, the supports 32 are shown as cylindrical columns. However, supports 32 having other cross-sectional areas, such as quadrilaterals, as discussed below can also be utilized in this disclosure.

Furthermore, FIG. 2 illustrates the lidar coverage diagram 50 providing an estimate of the regions blocked by one of the supports 32 or by one of the lidar sensors 36-1 or 36-2. As shown in FIG. 2, a first group of obstruction triangles or regions 52 approximate an obstructed field of view of the first lidar sensor 36-1 by the supports 32 and a first lidar obstruction region 54 showing a region where the second lidar sensor 36-2 is obstructing the field of view of the first lidar sensor 36-1. Similarly, a second group of obstruction triangles or regions 56 approximate an obstructed field of view of the second lidar sensor 36-2 by the supports 32 and a second lidar obstruction region 58 showing a region that the first lidar sensor 36-1 is obstructing the field of view of the second lidar sensor 36-2. Accordingly, one feature of the arrangement of FIG. 2 is to improve the field of view of the first and second lidar sensors 36-1 and 36-2 while still providing protection to them.

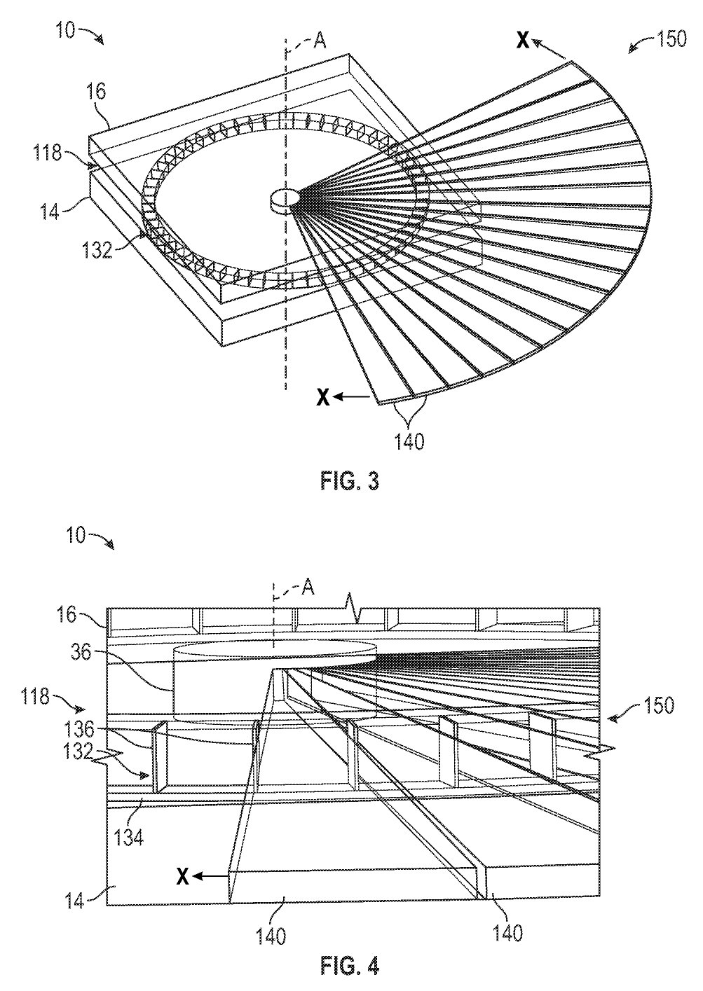

FIGS. 3-4 illustrate another example sensor portion 118 for the AMR 10. The sensor portion 118 is similar to the sensor portion 18 except where described below or shown in the drawings. The sensor portion 118 includes a support structure 132 extending between the base portion 14 and the upper portion 16. In the illustrated example, the support structure 132 forms a circular ring that completely surrounds a single lidar sensor 36 with the lidar sensor 36 shown in a central region of the sensor portion 118 and being configured to emit and receive light beams in 360 degrees around the AMR 10.

The support structure 132 forms a ring and includes a first circular flange 134 centered on the lidar sensor 36 and legs 136 extending in an axial direction relative to a central longitudinal axis A from an axially facing surface of the first circular flange 134. The legs 136 extend in a radial direction relative to the axis A. One feature of the legs 136 extending in the radial direction is to reduce the obstruction of the lidar sensor 36 while still providing significant load transferring ability between the base portion 14 and the upper portion 16 due to the length of the leg 136 in the radial direction. In one example, a length of the leg 136 in the radial direction is greater than five times a width of the leg 136 in a circumferential direction and in another example, the length of the leg 136 in the radial direction is greater than ten times the width of the leg 136 in the circumferential direction. In this disclosure, radial or radially, axial or axially, and circumference or circumferentially are with respect to the axis A unless stated otherwise.

As shown by the lidar projection regions 140 in the lidar coverage diagram 150, the lidar sensor 36 maintains a significant field of view when utilizing the support structure 132 with the legs 136. Also, for ease of illustration, the lidar projection regions 140 are illustrated along a segment of the 360 degrees of projection that the lidar sensor 36 is capable of and the projection regions 140 would continue to surround the entire AMR 10 circumferentially in the direction of the arrows X.

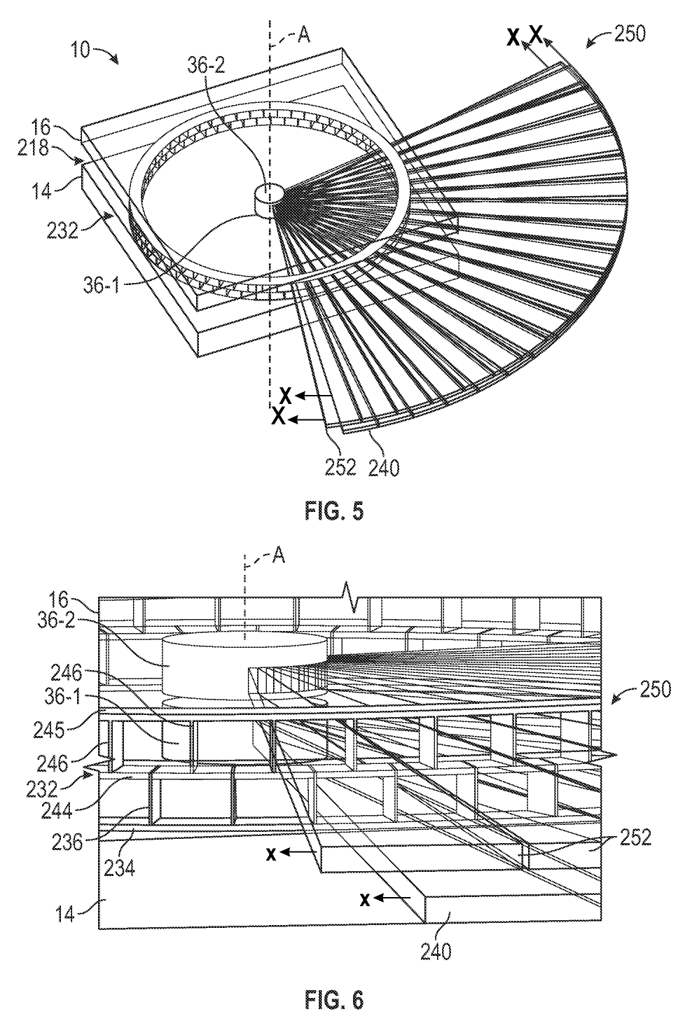

FIGS. 5-6 illustrate another example sensor portion 218 for the AMR 10. The sensor portion 218 is similar to the sensor portions 18 and 118 except where described below or shown in the drawings. The sensor portion 218 includes a support structure 232 extending between the base portion 14 and the upper portion 16. In the illustrated example, the support structure 232 forms a circular ring that completely surrounds a first lidar sensor 36-1 and a second lidar sensor 36-2 with both the first lidar sensor 36-1 and the second lidar sensor 36-2 shown in a central region of the sensor portion 218 and being configured to emit and receive light beams in 360 degrees around the AMR 10.

The support structure 232 forms a first ring and includes a first circular flange 234 centered on the first lidar sensor 36-1 with first legs 236 extending in an axial direction relative to a central longitudinal axis A of the ring. The legs 236 extend in a radial direction relative to the axis A from an axially facing surface of the first circular flange 234. One feature of the legs 236 extending in the radial direction is to reduce the obstruction of the first lidar sensor 36-1 while still providing significant load transferring ability between the base portion 14 and the upper portion 16 due to the length of the leg in the radial direction.

The support structure 232 also includes a second ring that includes a second circular flange 244 and a third circular flange 245 centered on the second lidar sensor 36-2 with second legs 246 extending in an axial direction relative to the central longitudinal axis A and from axially facing surfaces of the second and third flanges 244 and 245. The second legs 246 extend in a radial direction relative to the axis A. One feature of the second legs 246 extending in the radial direction is to reduce the obstruction of the second lidar sensor 36-2 while still providing significant load transferring ability between the base portion 14 and the upper portion 16 due to the length of the leg in the radial direction. Additionally, the first legs 236 are circumferentially offset from the second legs 246 to improve the overlap of the field of view of the first and second lidar sensors 36-1 and 36-2 collectively.

In one example, a length of the first or second legs 236 and 246 in the radial direction is greater than five times a width of the first and second leg 236 and 246 in a circumferential direction and in another example, the length of the first and second legs 236 and 246 in the radial direction is greater than ten times the width of the first and second legs 236 and 246 in the circumferential direction.

As shown in the first lidar projection regions 240 for the first lidar sensor 36-1 and the second lidar projection regions 252 for the second lidar sensor 36-2 of the lidar coverage diagram 250, the first and second lidar sensors 36-1 and 36-2 maintain a significant field of view when utilizing the first legs 236 circumferentially offset from the second legs 246. Also, for ease of illustration, the lidar projection regions 240 and 252 are illustrated along a segment of the 360 degrees of projection that the first and second lidar sensors 36-1 and 36-2 are capable of and the projection regions 240 and 252 would continue to surround the entire AMR 10 in the direction of the arrows X.

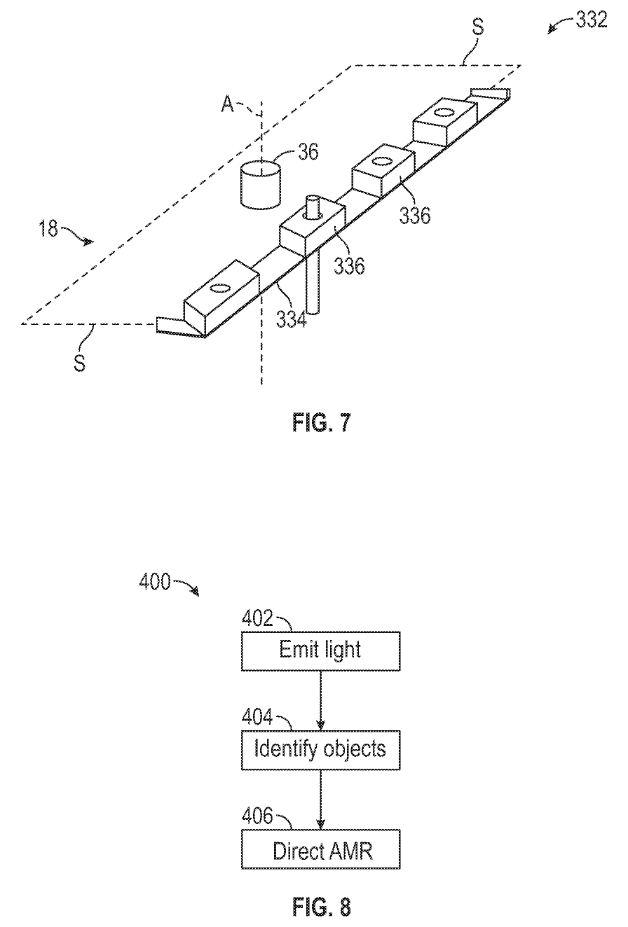

FIG. 7 illustrates another example support structure 332 for use in the sensor portion 18 of the AMR 10. In the illustrated example, the support structure 332 forms non-circular shape, such as a quadrilateral, that completely surrounds one of the lidar sensors 36 located in a central region of the sensor portion 18 and being configured to emit and receive light beams in 360 degrees around the AMR 10.

The support structure 332 includes a first flange 334 centered on the lidar sensor 36 and projections 336 having a quadrilateral cross-section extending in an axial direction relative to a central longitudinal axis A of the support structure 332. The projections 336 include opposing ends that extend in a radial direction relative to the axis A. One feature of opposing ends extending in the radial direction is to reduce the obstruction of the lidar sensor 36 while still providing significant load transferring ability between the base portion 14 and the upper portion 16. The projections 336 can also include conduits C for passing wires W or other elements through the sensor portion 18 without providing additional obstruction of the lidar sensor 36.

FIG. 8 illustrates a method 400 of operating the AMR 10. The method 400 begins at block 402 (“Emit light”), with the controller 28 directing the lidar sensor(s) 36 to emit light. In one example, the light from the lidar sensor(s) is emitted in a 360 degree pattern surrounding the lidar sensor(s) 36. Once the light is emitted from the lidar sensor(s) 36, the method 400 proceeds to block 404.

At block 404 (“Identify Object(s)”), the method 400 identifies the presence of objects within predetermined distance of the lidar sensor(s) 36 on the AMR 10. The method 400 identifies objects within the predetermined range by receiving the light emitted by the lidar sensor 36 after it has reflected off the object. If the emitted light is reflected off an object within the predetermined distance of the AMR 10 and the lidar sensor 36, the method 400 can determine the presence of the object. Once the objects have been identified, the method 400 then proceeds to block 406.

At block 406 (“Direct AMR”), the method 400 determines a path for the AMR 10 to follow based on the object(s) identified by the lidar sensor 36 in block 404. The method 400 can utilize the controller 28 to actuate the drive unit 20 to continue movement of the AMR 10 along a preexisting path, stop the AMR 10 until the object has left the preexisting path of the AMR 10, or reroute the AMR 10 along a new path unobstructed by the object(s). If the AMR 10 is unable to proceed along the preexisting path or determine a new path, the controller 28 can communicate wirelessly with a remote location 46 to receive assistance. Once the AMR 10 has reached its final destination, the method 400 can end.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A vehicle, comprising:
a body including a base portion spaced from an upper portion;
a sensor portion separating the upper portion from the base portion, wherein the sensor portion includes at least one sensor located between the base portion and the upper portion with a support structure circumferentially spaced around the at least one sensor and configured to engage the base portion and the upper portion;
a drive unit including a drive motor in driving engagement with a plurality of drive wheels that are configured to engage a support surface; and
a plurality of guide wheels rotatably attached to the base portion for supporting the vehicle along the support surface.

2. The vehicle of claim 1, wherein the support structure includes a plurality of columns surrounding the at least one sensor.

3. The vehicle of claim 2, wherein the plurality of columns are cylindrical.

4. The vehicle of claim 2, wherein the plurality of columns are quadrilateral.

5. The vehicle of claim 2, wherein the at least one sensor includes a plurality of lidar sensors surrounded by the support structure.

6. The vehicle of claim 2, wherein at least one of the plurality of columns at least partially defines a conduit forming a portion of a passageway between the base portion and the upper portion.

7. The vehicle of claim 1, wherein the support structure forms a first ring surrounding the at least one sensor.

8. The vehicle of claim 7, wherein the at least one sensor includes a first lidar sensor located at a center of the first ring.

9. The vehicle of claim 8, wherein the first ring includes a first circular flange with a first plurality of legs extending from an axially facing surface of the first circular flange.

10. The vehicle of claim 9, wherein the first plurality of legs extend in a radial direction that is aligned with the center of the first ring.

11. The vehicle of claim 10, wherein the support structure includes a second ring having a second circular flange and a second plurality of legs extending from an axial surface of the second circular flange.

12. The vehicle of claim 11, wherein the at least one sensor includes a second lidar sensor located at a center of the second ring and axially spaced from the first lidar sensor.

13. The vehicle of claim 11, wherein the first plurality of legs are circumferentially offset from the second plurality of legs.

14. An assembly, comprising:
a body including a base portion spaced from an upper portion;
a sensor portion separating the upper portion from the base portion, wherein the sensor portion includes at least one lidar sensor located between the base portion and the upper portion with a support structure circumferentially spaced around the at least one lidar sensor and configured to engage the base portion and the upper portion;
a controller in electrical communication with the at least one lidar sensor, wherein the controller is configured to:
direct the at least one lidar sensor to emit light in a 360 degree pattern; and
identify an object surrounding the assembly based on the emitted light reflecting off the object.

15. The autonomous mobile robot of claim 14, wherein the support structure includes a plurality of columns surrounding the at least one lidar sensor.

16. The autonomous mobile robot of claim 14, wherein the support structure forms a first ring surrounding the at least one lidar sensor, the first ring includes a first circular flange with a first plurality of legs extending from an axially facing surface of the first circular flange, and the first plurality of legs extend in a radial direction that is aligned with a center of the first ring.

17. The autonomous mobile robot of claim 10, wherein the support structure includes a second ring having a second circular flange, a second plurality of legs extending from an axial surface of the second circular flange, and the at least one lidar sensor includes a second lidar sensor located at a center of the second ring and axially spaced from the first lidar sensor.

18. A method of operating an autonomous mobile robot, the method comprising:
emitting light from at least one lidar sensor on the autonomous mobile robot in a 360 degree pattern, wherein the autonomous mobile robot includes:
a body including a base portion spaced from an upper portion;
a sensor portion separating the upper portion from the base portion, wherein the sensor portion includes at least one lidar sensor located between the base portion and the upper portion with a support structure circumferentially spaced around the at least one lidar sensor and configured to engage the base portion and the upper portion;
a drive unit including a drive motor in driving engagement with a plurality of drive wheels that are configured to engage a support surface; and
a plurality of guide wheels rotatably attached to the base portion for supporting the autonomous mobile robot along the support surface;
identifying an object surrounding the autonomous mobile robot based on the emitted light reflecting off the object; and
directing the autonomous mobile robot with the drive unit to follow a path based on the object identified by the at least one lidar sensor.

19. The method of claim 18, wherein the at least one lidar sensor includes a first lidar sensor, the support structure forms a first ring surrounding the first lidar sensor, the first ring includes a first circular flange with a first plurality of legs extending from an axially facing surface of the first circular flange, and the first plurality of legs extend in a radial direction that is aligned with a center of the first ring.

20. The method of claim 19, wherein the support structure includes a second ring having a second circular flange, a second plurality of legs extending from an axial surface of the second circular flange, and the at least one lidar sensor includes a second lidar sensor located at a center of the second ring and axially spaced from the first lidar sensor.
